(19) United States
(12) Patent Application Publication
(10) Pub. No.: US 2019/0114602 A1
(43) Pub. Date: Apr. 18, 2019

(54) Configuration Tool for Payment Processing

(71) Applicant: ModoPayments, LLC, Richardson, TX (US)

(72) Inventors: Cevat Kerim Incedayi, Berlin (DE); Adam D. Schnaare, Stratford, WI (US); Bruce Parker, Richardson, TX (US); Gregory W. Harvey, McKinney, TX (US); John F. Conley, III, College Station, TX (US); Colm Bergin, Dallas, TX (US)

(73) Assignee: ModoPayments, LLC, Richardson, TX (US)

(21) Appl. No.: 16/161,602

(22) Filed: Oct. 16, 2018

Related U.S. Application Data
(60) Provisional application No. 62/572,784, filed on Oct. 16, 2017.

(51) Int. Cl. G06Q 20/10; G06Q 20/38; G06Q 20/02; G06F 17/30

(52) U.S. Cl. CPC G06Q 20/102; G06F 17/30946; G06Q 20/02; G06Q 20/389

(57) ABSTRACT

A system of providing a receiver of payments access to a plurality of payment sources, is described that includes a configuration tool listing a plurality of payment sources available to the receiver of payments and configured to allow the receiver to select one or more disparate payment sources from which it will accept payments. The system then provides a payment interface for the receiver of payments displayable to customers of the receiver. A payment transaction database stores data related to financial transactions carried out on behalf of the receiver of payments. The system also includes a payment hub that provides an interface between the receiver of payments and the selected payment sources.

### CROSS REFERENCE TO RELATED INFORMATION

This application claims the benefit of U.S. Provisional Patent Application No. 62/572,784, filed Oct. 16, 2017, titled, “Configuration Tool For Payment Processing”, the contents of which are hereby incorporated herein in its entirety.

### TECHNICAL FIELD

The present disclosure is directed to payment processing, and more particularly to bi-directional translation and resolution systems and methods.

### BACKGROUND OF THE INVENTION

Banks, retailers, and other entities in today's economy must be able to accept or facilitate payments from a variety of digital sources and fiat hard currencies (or non-fiat digital currencies). This means that almost in every payment transaction between a payor and a recipient there can be multiple entities or companies involved in a single purchase. In addition to the multiple parties involved in any individual payment transaction, each party to a transaction may have different accounting systems, techniques, and protocols. Ensuring that each party is correctly paid or made whole in a timely manner can be difficult. These types of situations, and others like it, can be difficult to track from an accounting perspective.

In addition to the complexity seen in existing (also called legacy) systems, swift change has come at a rapid pace across a wide-ranging set of elements throughout the payments business. From technology advancements in plastic cards (the addition of chips replacing magnetic stripes on the back of cards), to mobile payments driven by the overwhelming adoption of “smartphones” (internet connected miniaturized computers) and devices to tokenization, the industry is becoming even more complex.

### BRIEF SUMMARY OF THE INVENTION

The present disclosure includes methods and systems for processing, funding, and tracking financial transactions on behalf of a merchant, service provider, retailer, or other company that receives payments—hereinafter referred to as a receiver. A configuration tool can act on behalf of a receiver to carry out purchases made on the receiver's website or mobile application. The configuration tool can interface and communicate with a plurality of payment sources or providers, such as banks, credit cards, services like Paypal™, and more. By communicating and directing the flow of funds on behalf of the receiver and other parties, the receiver and other parties can avoid the costs and complexities of frequent and changing system updates required by each party to a transaction. The configuration tool can act as an intermediary for other systems and handle the difficult interoperability problems. The configuration tool can act as a payment passport for each party to a transaction.

In a preferred embodiment, a system of providing a receiver of payments access to a plurality of payment sources is described. The system includes a configuration tool listing the plurality of payment sources available to the receiver and configured to allow the receiver to select one or more of the plurality of payment sources from which it will accept payments. The configuration tool may also provide a payment interface for the receiver displayable to customers of the receiver. A payment transaction database is configured to store data related to financial transactions carried out on behalf of the receiver and is further configured to provide the receiver a user interface to create a report or search query on stored data. A payment hub provides an interface between the receiver and the one or more of payment sources selected by the receiver using the configuration tool. The payment hub stores the data related to the financial transactions in the payment transaction database.

In another embodiment, a method of configuring payment source options for a receiver of payments includes displaying to the receiver a plurality of available payment sources and receiving a selection by the receiver of one or more desired payment sources. The method further includes receiving from the receiver information required to process payments on behalf of the receiver and creating a payment interface usable by the receiver to collect online payments.

In yet another embodiment, a method for processing payments on behalf of a receiver of online payments is described. The method displays a payment interface to a customer of the receiver of online payments, the payment interface including one or more payments options from a plurality of payment options. The method further includes receiving a selection of a payment option from the customer and receiving payment credentials for the payment option from the customer. The method processes the payment according to the payment credentials and the payment source. Transaction data is stored in a database separate from the receiver of payments, and payment flows directly from a source of the payment according to the payment option to the receiver of payments.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an embodiment of a payment configuration, interface and processing system according to the concepts described herein;

FIG. 2 is a series of exemplary screen shots from an embodiment of a payment configuration system according to the concepts described herein;

FIG. 3 is a series of exemplary screen shots from an embodiment of a payment configuration system according to the concepts described herein;

FIG. 4 is a series of exemplary screen shots from an embodiment of a payment configuration and report system according to the concepts described herein;

FIG. 5 is a series of exemplary screen shots from an embodiment of a payment configuration and processing system according to the concepts described herein;

FIG. 6 is a state diagram and flow chart for an embodiment of a payment processing system according to the concepts described herein;

FIG. 7 is a state diagram and flow chart for an alternate embodiment of a payment processing system according to the concepts described herein;

FIG. 8 is a block diagram of an embodiment of a payment processing system and method according to the concepts described herein;

FIG. 9 is a block diagram of an embodiment of a payment processing system and method according to the concepts described herein;

FIG. 10 is a flow chart of an embodiment of a method of creating a COIN according to the concepts described herein; and

FIG. 11. Is a flow chart of an embodiment of a method for configuring, processing and storing payment transactions from a plurality of payment sources according to the concepts described herein.

### DETAILED DESCRIPTION OF THE INVENTION

Embodiments under the present disclosure include methods and systems for enabling payment for online, and other, transactions across a wide variety of payment methods that a receiver may choose. Currently, a receiver may offer customers several different payment options. For example, a receiver may allow a user to pay with different payment providers such as a credit card, debit card, payment service such as Paypal™, or others. Problems can arise as different payment providers change their security settings, application programming interface (API) language or protocol, required credentials, or make other adjustments to their system when these changes necessitate a change in the receiver's payment systems. A configuration tool or configurator under the present disclosure allows a receiver to interact with a single payment passport or payment configuration entity (or configurator). The configurator can interact with credit cards, debit cards, Paypal, or other payment providers on the receiver's behalf. This way, the configurator can provide the receiver a single receiver-facing interface for payments, while still allowing compatibility with a number of payment providers or sources. The configurator can update its system as each payment provider updates, providing the receiver a seamless experience. The configurator can also serve as a transaction repository, tracking and maintaining records on all the receiver's receipts and transactions.

One benefit of embodiments under the present disclosure is that a receiver may not have to store payment information for its customers. Instead, a payment configuration entity can handle financial transactions on behalf of the receiver and store payment information as needed. In this way security can be handled by the payment configuration entity, not the receiver who is likely not an expert on financial, internet, or cryptographic security. If many receivers utilize the payment configuration entity, then there may be fewer targets for hackers.

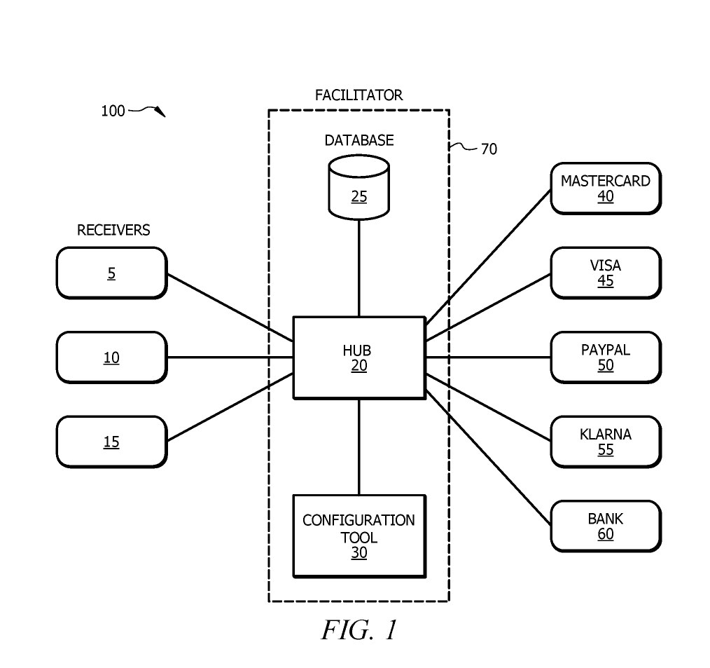

FIG. 1 displays one possible embodiment of a configuration tool and system 100 under the present disclosure. Receivers 5, 10, 15 can comprise any type of online receiver. As users shop at the receivers 5, 10, 15, they may be wishing to pay with various payment sources or providers such as Mastercard™ 40, VISA™ 45, Paypal 50, Klarna™ 55, or a bank 60. Other funding sources or providers can be used as well. A hub 20 can sit between the receivers 5-15 and the payment sources 40-60. Hub 20 can comprise, or be coupled to, a payment transaction database 25 and a configuration tool 30. The database 25 can store transaction data for all, or a subset, of the transactions performed using the hub 20. Configuration tool 30 can allow hub 20 to communicate with any payment source 40-60 and any receiver 5-15 and to translate communications between any connected party, as necessary. The hub 20, configuration tool 30 and transaction database 25 may be operated and maintained by an payment facilitator 70 separate from the receivers and payment sources.

Payment sources 40-60 may each have different software languages, different APIs, communication protocols, payment schedules, funding rules, and other design aspects. It is difficult for receiver 5, for example, to keep up with each payment source 40-60 and all the system updates that would be required. Hub 20, with configuration tool (configurator) 30 can step in and give receiver 5 a single interface to work with. Hub 20 and configuration tool 30 can handle all communications with payment sources 40-60 on behalf of the receiver.

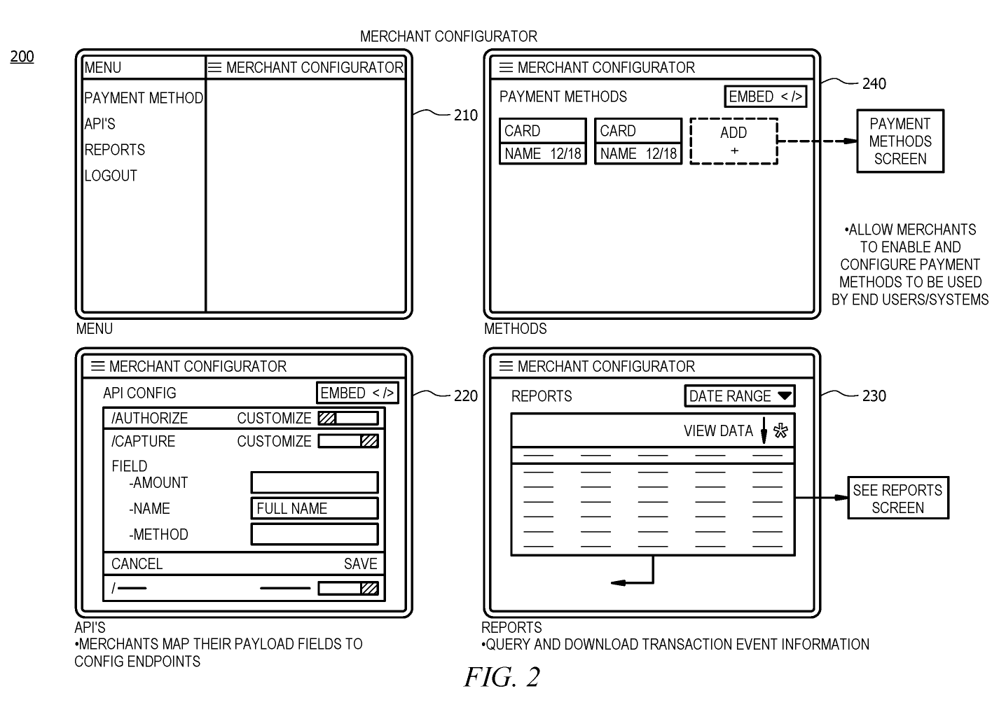

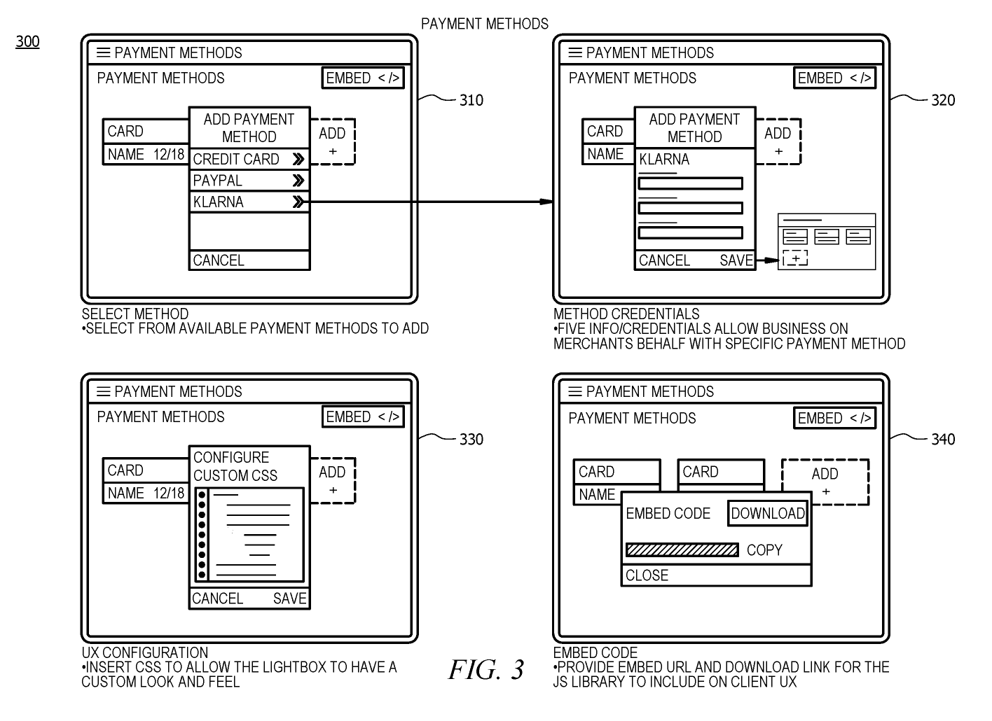

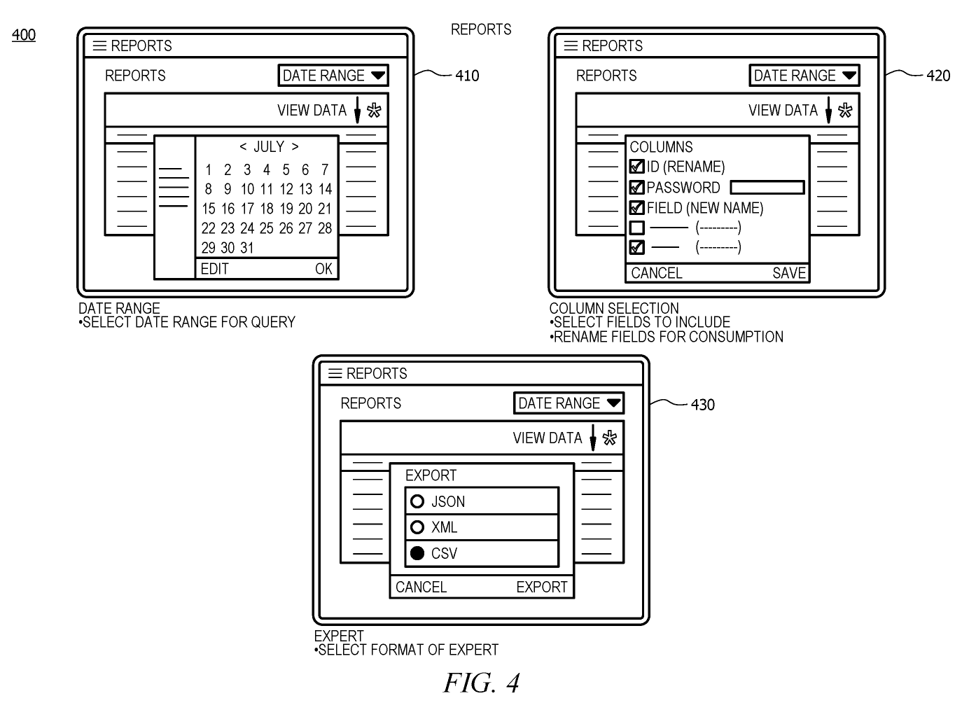

FIG. 2 displays possible embodiments of a user interface by which a receiver 5-15 of FIG. 1 signs up for or manages an account with Hub 20 and configurator 30. A receiver may sign up for an account, or login to an existing account, and see screen 210. Screen 210 gives the receiver three main options (though others are possible). One is an option to manage payment methods, seen in screen 240. Another is API management, seen in screen 220. Another is report viewing, seen in screen 230. Choosing screen 240 allows the user to manage, add, remove or otherwise edit payment methods (see discussion of FIG. 3 below). Choosing screen 230 allows the user to run, view, and otherwise manage report capabilities of the system (see discussion of FIG. 4 below). Choosing screen 220 allows the user to edit the API settings that control the communications between the receiver and the Hub 20 or configurator 30 of FIG. 1. Settings that can be changed include time schedules, software languages or settings, software code, connection method, telecommunication network, internet addresses, ftp address, account numbers, authorization codes, maximum and minimum payment amounts, and other factors.

FIG. 3 shows possible embodiments of interfaces 300 allowing a receiver 5-15 to add a new payment method. At interface 310 the receiver can be presented with a list of possible payment methods, such as payment sources 40-60 of FIG. 1. Once the receiver selects a payment method to add, it can be presented with screen 320 which may require the receiver to input some account information, such as the receiver's account information with the payment source, such as a preexisting account number. Alternatively, screen 320 may allow the receiver to initiate an account with the payment source. Filling out this screen can allow the Hub or configurator to do business on behalf of the receiver with the payment source. Saving the information will place the newly added payment method on the payment methods home screen (screen 240 of FIG. 2). Screen 330 allows the receiver to edit a CSS (cascading style sheets) page to display to a user when the newly added payment method is chosen. While the use of CSS is common currently, another formatting or coding tool or language could be used. Once the CSS is saved, the receiver can be presented with an embed code screen 340, giving the receiver a code to embed in its website on the payment page.

FIG. 4 shows possible embodiments of interfaces 400 allowing a user to review, create, and manage reports of transaction or financial data. The receiver could choose a range of values in screen 410, such as a data range, a dollar amount range, a payment provider or source, or another factor. In screen 420 the receiver can choose specific data to return in a report, such as columns showing dollar amount, data, names, account numbers, or other data. In screen 430 the receiver can choose to export or view the data in a variety of formats, such as xml or csv.

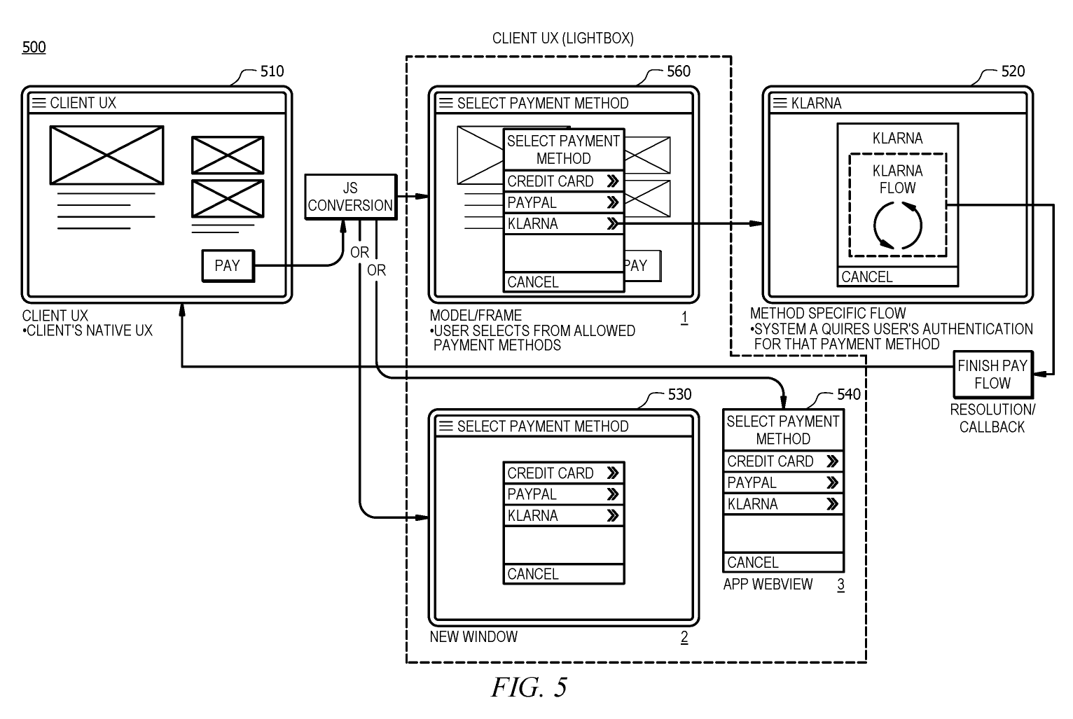

FIG. 5 shows a possible embodiment of a user interface 500 by which a consumer can interact with a receiver's platform such as receivers 5-15 of FIG. 1. While this interface can be consumer facing, a similar embodiment could allow for business to business (B2B) interactions and purchasing and invoicing. The consumer may access an online store via a desktop, laptop, mobile device or other connected device. Screen 510 can comprise the checkout page of the receiver's website or mobile application. Pressing ‘pay’ can enact a javascript or other software that connects to the hub 20 and the configurator 30 of FIG. 1, and passes certain information including details of the order, the identification of the customer, and a unique identifier for the receiver. The javascript can be initialized by passing cart details, customer information, and a unique identifier for the merchant to the hub 20. A new window 530 could be opened, an iFrame window could be opened 560, or an application webview 540 could be opened, depending on the application, browser, or platform. Whatever window is shown, 530, 540 or 560, the consumer can choose a payment method, such as credit card, Paypal, Klarna, or others. Once a method is chosen, screen 520 shows that the receiver's online system will connect to the hub 20 and hub 20 and configurator 30 will handle the rest of the checkout by communicating with the chosen payment method (such as payment sources 40-60), confirming credentials for payment, and approving or receiving approval for a transaction.

When the hub 20 and/or configurator 30 carries out a financial transaction on behalf of a receiver, the funds will preferably not pass through an account associated with the hub 20 or hub operator. In preferred embodiments, hub 20 or configurator 30 will communicate with a payment account and give directions to the payment account for depositing money in a receiver's account. Hub 20 will preferably save data about the transaction for storage in transaction database 25.

The interactions of hub 20 with payment sources 40-60 for a given transaction may include communications and transfers between multiple parties. For example, a consumer may choose to pay with Paypal 50 at the receiver's website. In some embodiments, hub 20 will communicate with Paypal to fund the purchase, and the funds will be directed to the receiver's account with bank 60. In some embodiments, the transfer of funds will be controlled by Hub 20/configurator 30. In other embodiments Paypal 50 may have its own backend system for the transfer of money. Similarly, a Paypal account may draw from Mastercard 40 for payment to the receiver's account at bank 60. The Hub 20/configurator 30 may provide directions to all involved parties regarding these transfers of funds.

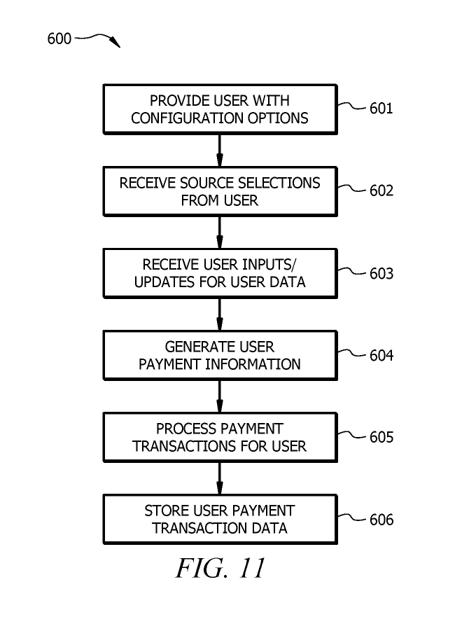

Referring now to FIG. 11, a method 600 of configuring payment transactions for a receiver or user is shown. In block 601 the user or receiver is provided with a set of configuration options. The set of options is preferably shown through a graphic user interface allowing the user to select the desired options, such as payment sources, as shown in block 602. Block 603 shows receiving or updating, as necessary, user information required to process payments on behalf of the receiver. This information can include bank information, account information, contact information, currency information and the like. Block 603 may be skipped or omitted if the user information has already be inputted.

Once all of the user selections and data are in place, the system can then generate a payment interface to be used on behalf of the user when the user's customers engage in a payment transaction with the user, as shown in block 604. The payment interface is preferably hosted by payment facilitator 70 from FIG. 1 and is accessed from the users storefront when the customer selects the payment option. Alternatively, the payment interface can be added directly to the user's storefront by the payment facilitator. Payment transactions can then be processed on behalf of the users, as shown by block 605. Payment transaction data is then stored as shown by block 606.

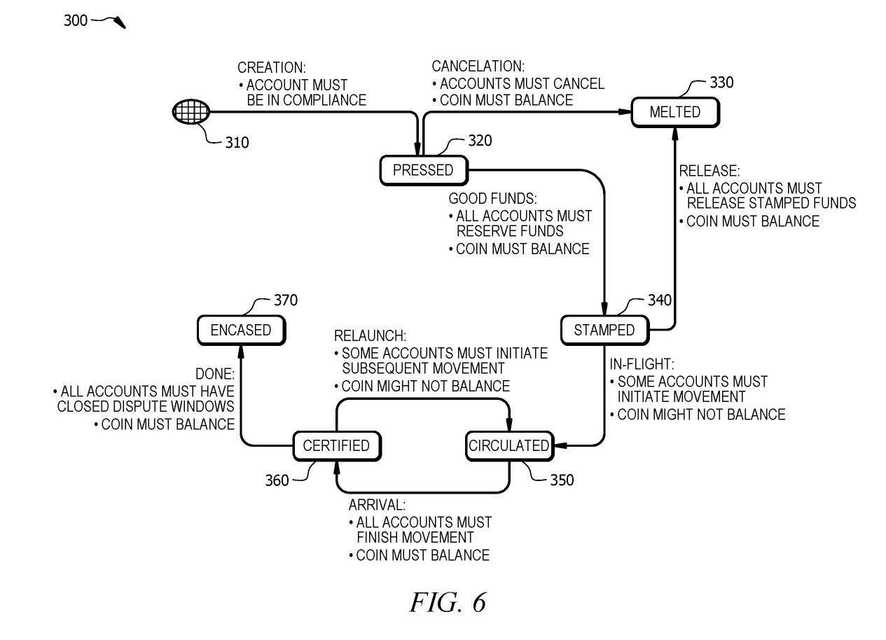

Hub 20 may associate financial transactions with a database tool called a COIN. The COIN may model a financial transaction and provide an accounting of an entire transaction. Different steps in the financial transaction can be modeled as Pressed, Melted, Stamped, Circulated, Certified, and Encased. FIG. 6 displays a possible embodiment of a COIN states model, shown as a flow chart 300. Beginning at 310, a COIN is created and at such creation all related accounts should be in compliance. When these steps are taken the COIN will have been pressed 320. When the related accounts have reserved funds and the COIN is balanced, then the COIN is stamped 340. From pressing, a COIN may pass to either melting 330 or stamping 340.

A COIN is melted at 330 when a transaction or account is canceled. To be melted all accounts must cancel and the COIN should balance. From stamping 340, a COIN may pass onto circulation 350. At circulation, some related accounts must initiate movement, such as a transfer of funds, and a circulating COIN may not balance from an accounting perspective. If melted after stamping, the related accounts that initiated movement of funds must have their funds released from receiving parties and the COIN must balance. If the COIN is circulated 350, then the system will wait for movement on all funds to finish and for the COIN to balance. Once movement is complete and the COIN is balanced, then the COIN will be certified 360. After certification 360, it may be that further movement of funds is needed and the COIN is relaunched to be circulated again at 350. Subsequent movement may be needed for various reasons, some transfer of funds may have been dependent on a previous transfer, or a recalculation may vary the amounts due by each account.

From certification 360, the COIN may also proceed to being encased 370. At encasing, all the related accounts must have closed dispute windows and the COIN must balance. Another shorthand way of describing each state is as follows. Pressed means that COIN participants are verified (e.g. terms agreed to, etc.). Stamped means that funds have been reserved or shown to be good funds (e.g. balance check, hold placed, etc.). Circulated means that fund movement has initiated (e.g. authorization has been captured, wire sent, etc.). Certified means that fund movement has finished (e.g. settlement, etc.). Encased means that fund movement is finalized (e.g. dispute window closed, etc.). Melted means that fund movement is canceled (e.g. authorization canceled, etc.). This state model can provide the means of normalizing the tracking of the COIN's view of the COIN accounts so that the COIN is able to treat each external transaction system in a consistent way with the details on differences handled by the COIN account implementations. The implementation of Pressed, Stamped, Circulated, Certified, Encased, and Melted states can allow the methods and systems that are being disclosed to work correctly with disparate financial systems that behave differently in accomplishing exchange of value or exchange of currency.

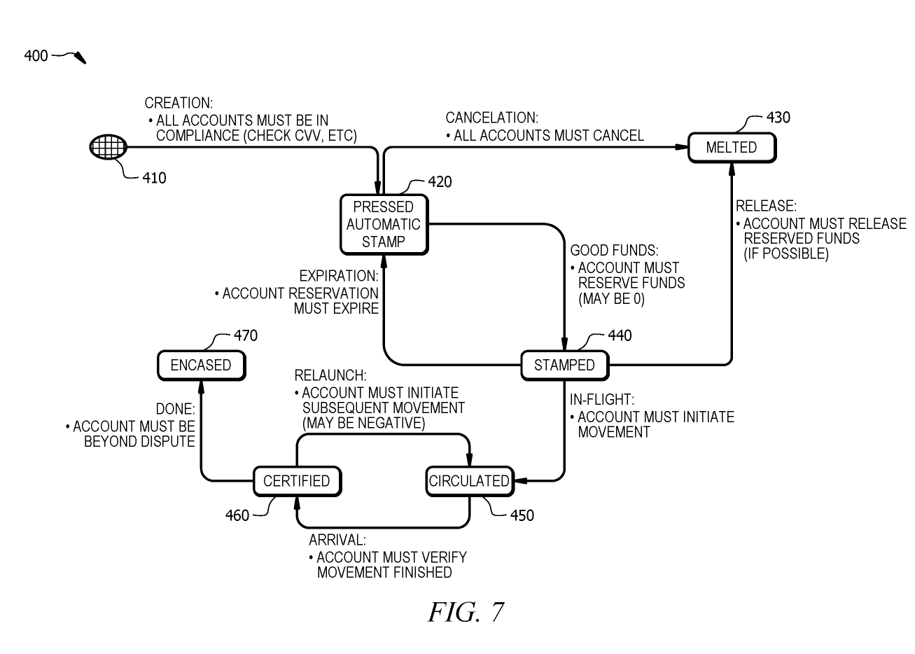

FIG. 7 shows a flow chart diagram, similar to FIG. 6, of the COIN account model, but from an accounting perspective. FIG. 7 comprises an embodiment 400 with the same state labels, creation 410, pressed 420, melted 430, stamped 440, circulated 450, certified 460, and encased 470 (and very similar semantics) to the COIN state model. As shown in FIG. 7, the accounting states are similar to the COIN states of FIG. 6. One difference is that a stamped COIN at 440 may expire, in which case the COIN will have to be re-pressed at 420.

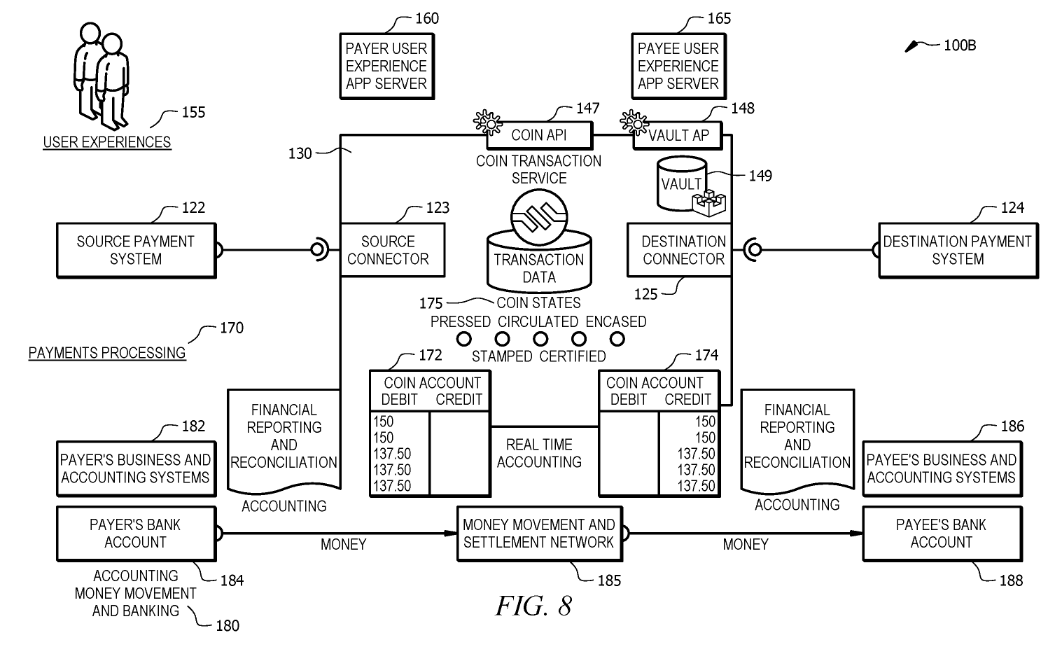

Another embodiment showing similar aspects and functionality as shown in FIG. 1 and further developing the database model of a COIN shown in FIGS. 6 and 7, can be seen in FIG. 8. System 100B comprises a COIN payment event data hub 130. Hub 130 may comprise a part of, or be connected to, hub 20 of FIG. 1. Element 155 generally denotes the user experience side of system 100B, while 180 generally denotes the money movement side of system 100B. App server 160, 165 may allow a user (payer or payee) to interact with hub 130 via an application programming interface such as COIN API 147 or vault API 148. Vault API 148 can allow user to view historical transaction data, or other stored data, in vault database 149. Source connector 123 can provide communication functionality with a source payment system 122, usually the payment account or system of the payer. Destination connector 125 can provide communication functionality with a destination payment system 124, usually the payment account or system of the payee. A given status change between one of the COIN states 175, can involve an accounting change from a debit 172 to a credit 174. This can adjust the status of a COIN associated with a financial transaction. The movement of funds associated with the transaction can occur generally at money movement 180. The payer's business or accounting systems, often associated with the source payment system 122 and a payer, can interact with a bank account 184 to engage a money movement and settlement network 185 to accomplish the transfer of funds to the payee's bank account 188 which interacts with the payee's business and accounting systems 186. The transfer of money can be accomplished through protocols and means communicated or supplied to the payer (and his systems and accounts 122, 160, 182, 184) and the payee (and his systems and accounts 124, 165, 186, 188) by the CTS 130 via connectors 122, 125.

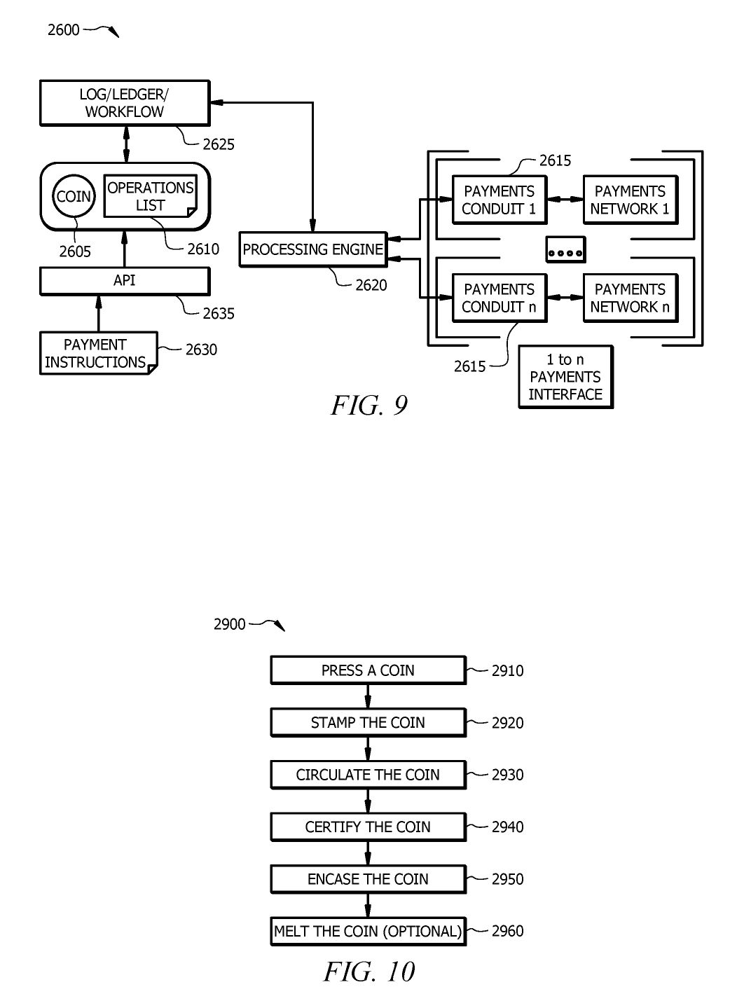

FIG. 9 is a block diagram of a COIN based payment operations 2600. When a payment request or payment instruction 2630 is received, a COIN 2605 may be created. Payment instructions 2630 may be received at an application programming interface (API) 2635. An operations list 2610 may be associated with COIN 2605. API 2635 may interact with COIN 2605 and operations list 2610. Operations list 2610 may comprise one or more payment operations that are required in order to complete the payment instructions 2630. Each payment operation is associated with a payment conduit 2615. There may be 1 to n payment operations each corresponding to a payment conduit 2615. For example, a first payment conduit may be related to a consumer requesting funds from the consumer's issuer. A second payment conduit may be related to a rebate offer from an offer provider. A third payment conduit may be related to a gift provided from a third party to the consumer via a gift card provider. A fourth payment conduit may be related to the merchant's acquirer for receiving payment. Log/ledger/workflow 2625 tracks the completion of payment operations in the operations list 2610. Processing engine 2620 may monitor or cause payment operations to execute. At the completion of all the payment operations in the operations list 2610, the COIN will be balanced from an accounting standpoint.

Another method embodiment 2900 under the present disclosure is shown in FIG. 10. Method 2900 comprises a method for monitoring and updating a status of a COIN, the COIN signifying transactions related to a payment event and associated ledger events. At 2910, the COIN is pressed, wherein pressing the COIN comprises validating one or more sets of credentials and one or more compliance functions. At 2920, the COIN is stamped, wherein stamping the COIN comprises authorizing debits and credits associated with the financial transaction. At 2930, the COIN is circulated, wherein circulating the COIN comprises communicating money movement instructions to the payment service provider, the bank, and the receiver. At 2940, the COIN is certified, wherein certifying the COIN comprises verifying with a system of record that an amount recorded as circulated is equal to an actually circulated amount. At 2950, the COIN is encased, wherein encasing the COIN comprises waiting for a dispute period to end and closing all further money movement once the dispute period has ended. Optionally, at any point during the process, the COIN can be melted at 2960, wherein melting the COIN comprises canceling the COIN and stopping all further transactions on the COIN.

While financial transactions can be modeled by a COIN as described herein, the Hub 20 and configuration tool 30 are not limited to embodiments employing a COIN accounting or database model.

To help illustrate how a financial transaction might be carried out under the present disclosure, reference can be made to FIG. 1. Retailer 10 may have a website or mobile application for shopping in which interface 510 of FIG. 5 is displayed to a consumer. In the website example, when a consumer presses the ‘pay’ button, a java script can be enabled that connects to the Hub 20 and/or configuration tool 30. Hub 20 can present the consumer with a list of payment options, such as in interface 560. The consumer could choose Paypal 50. Hub 20 can then receive authentication or account information from the consumer, allowing the hub 20 to approve a payment from Paypal 50. Information could include a username and password, pin, or other information. Once the hub 20 has confirmed that the funds from Paypal 50 are approved, it can send directions to Paypal 50 for how the funds should be disbursed. For instance, hub 20 may direct all funds for receiver 10 to a certain bank account with bank 60. In such a situation, hub 20 can provide Paypal 50 with wiring instructions for the transfer of funds to receiver 10 account with bank 60. Hub 20 could permanently store account or authentication information for receiver 10 so it can handle financial transactions on an ongoing basis for receiver 10.

Hub 20 could also manage financial transactions for Paypal 50. The consumer's account with Paypal 50 may draw funds from any of the other payment sources 40-60. Once Paypal 50 has funded the financial purchase, it may need to be paid back, or refunded by, for example VISA 45. Hub 20 may receive account information from Paypal 50 related to the consumer's VISA card and account. Hub 20 can then contact VISA 45 and send directions for the transfer of funds to Paypal 50.

The system and concepts described herein may be implemented in a variety of ways using a variety of computing platforms. In preferred embodiments, the system and concepts are run on web-based servers accessible by the receivers and in communication with the variety of payment sources. The system also preferably has access to traditional payment processing systems such as credit card, debit card, gift card payment systems as well as online payment systems such as Paypal, Klarna, Venmo, etc. The system may also include apps that run on mobile platforms or programs resident on local computers which communicate with remote or cloud based servers.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system of providing a receiver of payments access to a plurality of payment sources, comprising:
a configuration tool listing the plurality of payment sources available to the receiver and configured to allow the receiver to select one or more of the plurality of payment sources from which it will accept payments and to provide a payment interface for the receiver displayable to customers of the receiver;
a payment transaction database configured to store data related to financial transactions carried out on behalf of the receiver, the payment transaction database further configured to provide the receiver a user interface to create a report or search stored data; and
a payment hub providing an interface between the receiver and the one or more of payment sources selected by the receiver using the configuration tool, the payment hub storing the data related to the financial transactions in the payment transaction database.

2. The system of claim 1 wherein the payment transaction database is created and stored by a payment facilitator.

3. The system of claim 2 wherein funds are passed between the receiver and payment source without being passed through the payment facilitator.

4. The system of claim 1 wherein the plurality of payment sources include credit card, debit card and online payment sources.

5. The system of claim 1 wherein the configuration tool can also display report data related to the financial transactions.

6. The system of claim 1 wherein a COIN is used to identify and track all aspects of a payment transaction.

7. The system of claim 1 wherein the payment interface is separate from the receiver's online storefront.

8. A method of configuring payment source options for a receiver of payments, comprising:
displaying to the receiver a plurality of available payment sources;
receiving a selection by the receiver of one or more desired payment sources;
receiving from the receiver information required to process payments on behalf of the receiver; and
creating a payment interface usable by the receiver to collect online payments.

9. The method of claim 8 further comprising storing transaction data from the online payments processed on behalf of the receiver.

10. The method of claim 9 wherein the transaction data is created and stored by a payment facilitator.

11. The method of claim 10 wherein funds are passed between the receiver and payment source without being passed through the payment facilitator.

12. The method of claim 8 wherein the plurality of payment sources include credit card, debit card and online payment sources.

13. The method of claim 8 further comprising displaying report data related to the online payments.

14. The method of claim 8 wherein a COIN is used to identify and track all aspects of a payment transaction.

15. The method of claim 8 wherein the payment interface is separate from the receiver's online storefront.

16. A method for processing payments on behalf of a receiver of online payments, the system comprising:
displaying a payment interface to a customer of the receiver of online payments, the payment interface including one or more payments options from a plurality of payment options;
receiving a selection of a payment option from the customer;
receiving payment credentials for the payment option from the customer; and
processing the payment according to the payment credentials and the payment source, wherein transaction data is stored in a database separate from the receiver of payments, and wherein payment flows directly from a source of the payment according to the payment option to the receiver of payments.

17. The method of claim 16 wherein the method is performed by a payment facilitator.

18. The method of claim 17 wherein funds are passed between the receiver of payments and the payment source without being passed through the payment facilitator.

19. The method of claim 16 wherein the plurality of payment sources include credit card, debit card and online payment sources.

20. The method of claim 16 further comprising displaying report data to the receiver of payments related to the payments.
